(19) United States
(12) Patent Application Publication
(10) Pub. No.: US 2015/0323715 A1
(43) Pub. Date: Nov. 12, 2015

(54) METHOD FOR MANUFACTURING A COLOR FILTER, AND A COLOR FILTER

(71) Applicants: BOE TECHNOLOGY GROUP CO., LTD., Beijing (CN); BEIJING BOE DISPLAY TECHNOLOGY CO., LTD., Beijing (CN)

(72) Inventors: Yang XIAO, Beijing (CN); Qinrui QI, Beijing (CN); Zhijun XU, Beijing (CN); Hengying WANG, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 14/362,053

(22) PCT Filed: Dec. 16, 2013
(86) PCT No.: PCT/CN2013/089587

§ 371 Date: May 30, 2014

(30) Foreign Application Priority Data
Jul. 31, 2013 (CN) 201310328955.5

(51) Int. Cl. G02B 5/20; G02B 1/12

(52) U.S. Cl. CPC G02B 5/201; G02B 1/12

(57) ABSTRACT

The present invention discloses a method for manufacturing a color filter, and a color filter. The method for manufacturing a color filter comprises: providing a glass substrate; forming a layer of black matrix material on the glass substrate; and exposing the black matrix material to form a first substrate pattern layer, wherein the first substrate pattern layer comprises a black matrix, an alignment mark and a pixel opening area; wherein the part of the glass substrate that is not covered by the black matrix forms the pixel opening area, and the alignment mark is located in the pixel opening area.

### FIELD OF THE INVENTION

The present invention relates to the field of color filter manufacturing, and in particular, to a method for manufacturing a color filter, and a color filter.

### DESCRIPTION OF THE PRIOR ART

In the existing producing process of a CF (Color Filter), it is required to perform an exposure process and expose a photoresist (PR) via a mask plate in the form of proximity exposure to form a required pattern during the manufacturing of a black matrix (BM), a red color filter (R), a green color filter (G), a blue color filter (B) and a post spacer (PS). During the exposure process, an accurate exposure of the pattern can only be guaranteed after accurately aligning an alignment mark on the mask plate (Mask Alignment Mark) with an alignment mark on the substrate (Glass Alignment Mark, which is made via a black matrix (BM) process).

As shown in FIG. 1, it is a schematic diagram showing the alignment between a mask plate and a glass substrate in the prior art. When a small-sized panel is to be manufactured, a white glass area exists between panels, thus an alignment mark 1 may be made on the white glass area of the substrate for the alignment between the mask plate and the glass substrate.

However, when a large-sized panel is to be manufactured, multiple splicing is required, therefore, there is no corresponding white glass area for placing the alignment mark. A so-called large-sized panel refers to a panel that cannot be wholly exposed at a time by a mask plate, i.e., a panel that can only be wholly exposed by mask plates via multiple spliced exposures.

### SUMMARY OF THE INVENTION

The present invention provides a method for manufacturing a color filter, and a color filter, which can be applied for manufacturing a color filter of a large panel.

In one aspect of the present invention, there provides a method for manufacturing a color filter, which comprises:

providing a glass substrate;

forming a layer of black matrix material on the glass substrate; and

exposing the black matrix material to form a first substrate pattern layer, wherein the first substrate pattern layer comprises a black matrix, an alignment mark and a pixel opening area; wherein the part of the glass substrate that is not covered by the black matrix forms the pixel opening area, and the alignment mark is located in the pixel opening area.

The method for manufacturing a color filter further comprises:

performing a first exposing and developing process according to the alignment mark, and forming a color filter layer on the first substrate pattern layer of the glass substrate.

The step of performing a first exposing and developing process according to the alignment mark and forming a color filter layer on the first substrate pattern layer of the glass substrate comprises:

coating a first layer of photoresist on the first substrate pattern layer;

aligning and placing a first mask plate, according to the alignment mark, on the glass substrate coated with the first layer of photoresist, performing a first exposing and developing step, and forming a first color filter layer on the first substrate pattern layer of the glass substrate;

coating a second layer of photoresist on the first substrate pattern layer;

aligning and placing a second mask plate, according to the alignment mark, on the glass substrate coated with the second layer of photoresist, performing a second exposing and developing step, and forming a second color filter layer on the first substrate pattern layer of the glass substrate;

coating a third layer of photoresist on the first substrate pattern layer; and

aligning and placing a third mask plate, according to the alignment mark, on the glass substrate coated with the third layer of photoresist, performing a third exposing and developing step, and forming a third color filter layer on the first substrate pattern layer of the glass substrate.

The first color filter layer, the second color filter layer and the third color filter layer are a red color filter layer, a green color filter layer and a blue color filter layer, respectively;

The first color filter layer, the second color filter layer and the third color filter layer are a red color filter layer, a blue color filter layer and a green color filter layer, respectively;

The first color filter layer, the second color filter layer and the third color filter layer are a blue color filter layer, a red color filter layer and a green color filter layer, respectively;

The first color filter layer, the second color filter layer and the third color filter layer are a blue color filter layer, a green color filter layer and a red color filter layer, respectively;

The first color filter layer, the second color filter layer and the third color filter layer are a green color filter layer, a red color filter layer and a blue color filter layer, respectively; or

The first color filter layer, the second color filter layer and the third color filter layer are a green color filter layer, a blue color filter layer and a red color filter layer, respectively.

The method for manufacturing a color filter further comprises:

coating a fourth layer of photoresist on the color filter layer; and

aligning and placing a fourth mask plate, according to the alignment mark, on the glass substrate coated with the fourth layer of photoresist, performing a second exposing and developing process, and forming a post spacer pattern layer on the color filter layer of the glass substrate.

In another aspect of the present invention, there provides a color filter, comprising a glass substrate, wherein a first substrate pattern layer is provided on the glass substrate, and an alignment mark is provided in a pixel opening area of the first substrate pattern layer.

The alignment mark is a graph with an area less than or equal to 2500 square microns, and the graph is any one of a rectangle, a circle, a triangle or a polygon.

The alignment mark is a square with a side length less than or equal to 50 microns.

The first substrate pattern layer further comprises a black matrix, and the part of the glass substrate that is not covered by the black matrix forms the pixel opening area.

A color filter layer is provided on the first substrate pattern layer.

A post spacer pattern layer is provided on the color filter layer.

The above technical solutions of the present invention has the following beneficial effects:

In the present invention, the alignment mark is provided in the pixel opening area of the first substrate pattern layer, and in the subsequent process, the alignment mark is used for aligning a mask plate with a substrate and no additional place is occupied by the alignment mark, thus the present invention can be applicable for a situation in which no white glass exists when a large-panel color filter is to be manufactured.

### BRIEF DESCRIPTION OF THE DRAWINGS

FIG. 1 is a schematic diagram showing the alignment between the mask plate and the glass substrate in the prior art;

FIG. 2 is a schematic flow chart of an embodiment of the method for manufacturing a color filter according to the present invention;

FIG. 3 schematically shows a top view of a color filter after the process of step 23;

FIG. 4 schematically shows a sectional view in direction A-A of a color filter after the process of step 23;

FIG. 5 schematically shows a top view in direction A-A of a color filter after the process of step 25;

FIG. 6 schematically shows a sectional view of a color filter after the process of step 25;

FIG. 7 schematically shows a top view of a color filter after the process of step 27;

FIG. 8 schematically shows a sectional view in direction A-A of a color filter after the process of step 27;

FIG. 9 schematically shows a sectional view in direction B-B of a color filter after the process of step 27; and

FIG. 10 is a schematic diagram showing the alignment with a mask plate by using the color filter of the present invention.

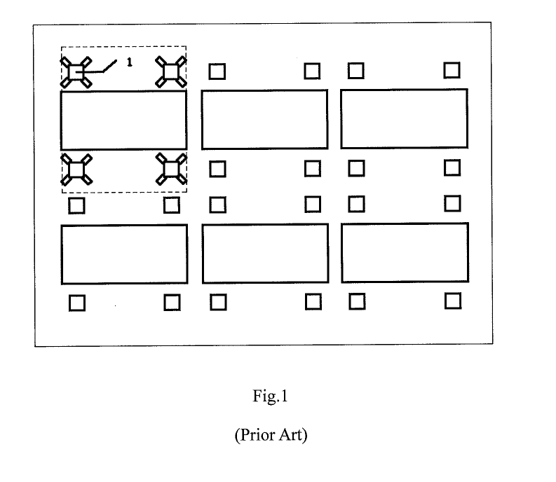

### DETAILED DESCRIPTION OF THE PREFERRED EMBODIMENTS

In order to make the technical problems to be solved, the technical solutions and the advantages of the present invention more apparently, the present invention will be described in detail below in conjunction with the drawings and specific embodiments.

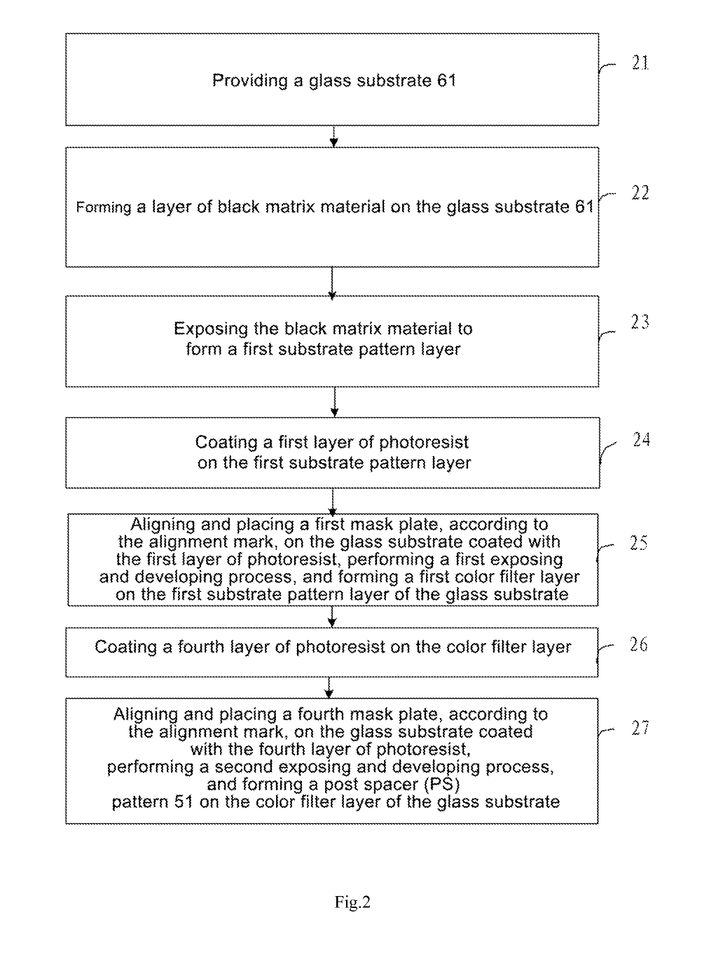

A method for manufacturing a color filter according to the present invention will be described below in conjunction with FIG. 2-FIG. 9. As shown in FIG. 2, the method includes:

Step 21: providing a glass substrate 61;

Step 22: forming a layer of black matrix material on the glass substrate 61;

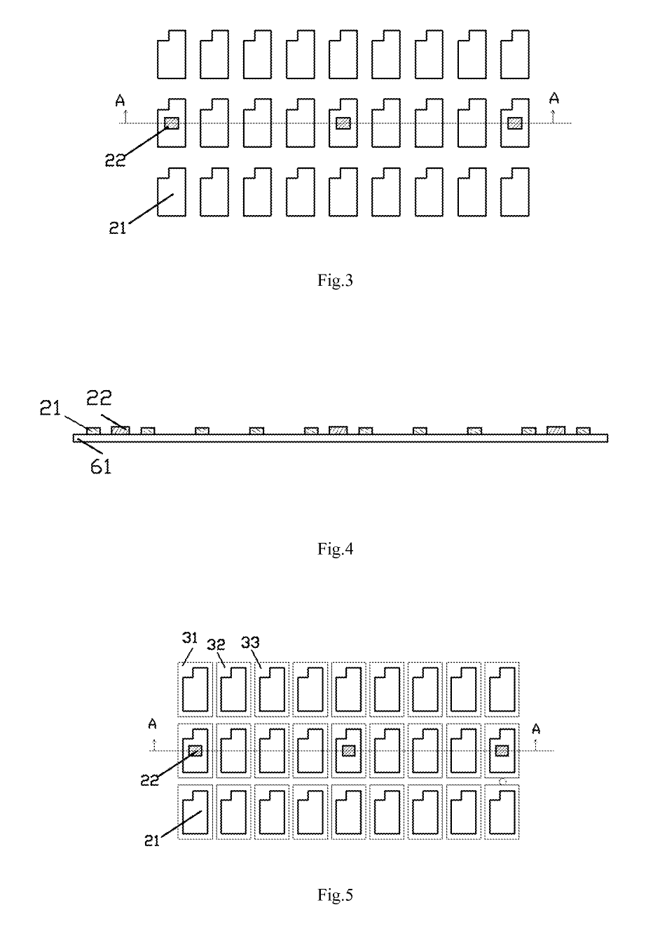

Step 23: exposing the black matrix material to form a first substrate pattern layer, wherein the first substrate pattern layer includes a black matrix 21, an alignment mark 22 and a pixel opening area; wherein the part of the glass substrate that is not covered by the black matrix forms the pixel opening area, and the alignment mark is located in the pixel opening area. FIG. 3 schematically shows a top view of a color filter after the process of Step 23; and FIG. 4 schematically shows a sectional view in direction A-A of a color filter after the process of Step 23. In this step, the alignment mark is made at the same time that the black matrix is manufactured. It should be noted that, the alignment mark is prepared at the same time with the black matrix, and the method for preparing the alignment mark is the same as that for preparing the black matrix, and the alignment mark is obtained by providing the graph of the alignment mark on the mask plate used and performing an exposing and developing process. Moreover, the material of the alignment mark is the same as that of the black matrix.

Preferably, the method for manufacturing a color filter further includes:

Step 24: coating a first layer of photoresist on the first substrate pattern layer; and

Step 25: performing a first exposing and developing process according to the alignment mark, and forming a color filter layer on the first substrate pattern layer of the glass substrate.

Specifically, Step 25 includes:

coating a first layer of photoresist on the first substrate pattern layer;

aligning and placing a first mask plate, according to the alignment mark, on the glass substrate coated with the first layer of photoresist, performing a first exposing and developing step, and forming a first color filter layer 31 on the first substrate pattern layer of the glass substrate;

coating a second layer of photoresist on the first substrate pattern layer;

aligning and placing a second mask plate, according to the alignment mark, on the glass substrate coated with the second layer of photoresist, performing a second exposing and developing step, and forming a second color filter layer 32 on the first substrate pattern layer of the glass substrate;

coating a third layer of photoresist on the first substrate pattern layer;

aligning and placing a third mask plate, according to the alignment mark, on the glass substrate coated with the third layer of photoresist, performing a third exposing and developing step, and forming a third color filter layer 33 on the first substrate pattern layer of the glass substrate.

The first color filter layer 31, the second color filter layer 32 and the third color filter layer 33 are a red color filter layer, a green color filter layer and a blue color filter layer, respectively; or

The first color filter layer 31, the second color filter layer 32 and the third color filter layer 33 are a red color filter layer, a blue color filter layer and a green color filter layer, respectively; or

The first color filter layer 31, the second color filter layer 32 and the third color filter layer 33 are a blue color filter layer, a red color filter layer and a green color filter layer, respectively; or

The first color filter layer 31, the second color filter layer 32 and the third color filter layer 33 are a blue color filter layer, a green color filter layer and a red color filter layer, respectively; or

The first color filter layer 31, the second color filter layer 32 and the third color filter layer 33 are a green color filter layer, a red color filter layer and a blue color filter layer, respectively; or

The first color filter layer 31, the second color filter layer 32 and the third color filter layer 33 are a green color filter layer, a blue color filter layer and a red color filter layer, respectively.

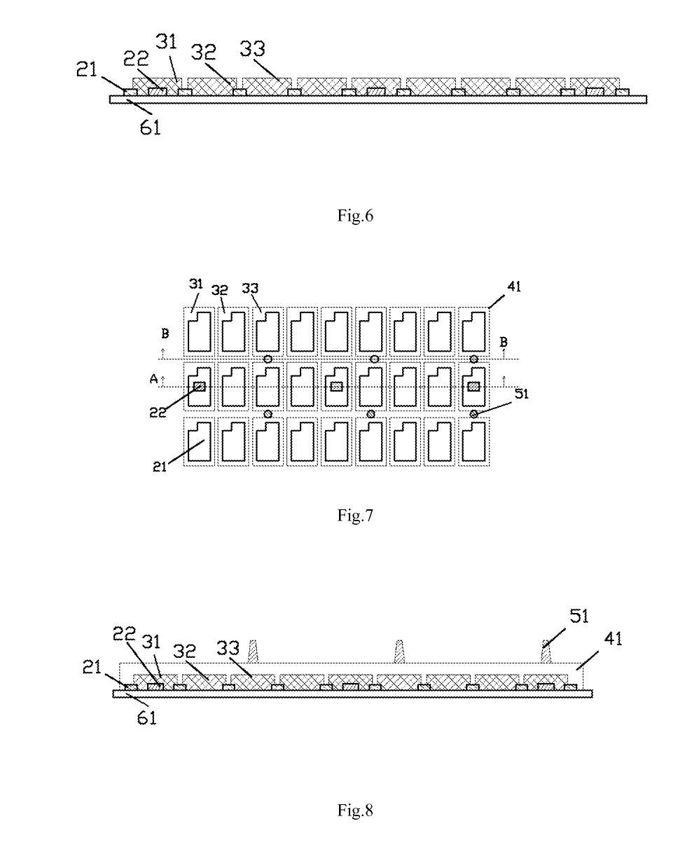

FIG. 5 schematically shows a top view in direction A-A of a color filter after the process of Step 25; and FIG. 6 schematically shows a sectional view of a color filter after the process of Step 25.

Preferably, the method for manufacturing a color filter further includes:

Step 26: coating a fourth layer of photoresist on the color filter layer; and

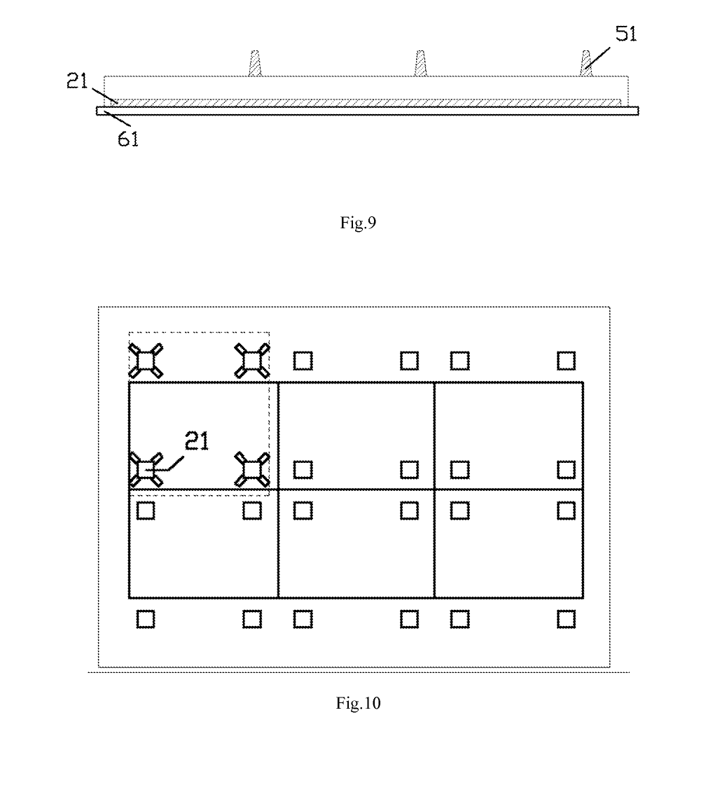

Step 27: aligning and placing a fourth mask plate, according to the alignment mark, on the glass substrate coated with the fourth layer of photoresist, performing a second exposing and developing process, and forming a post spacer pattern layer 51 on the color filter layer of the glass substrate. FIG. 7 schematically shows a top view of a color filter after the process of Step 27; FIG. 8 schematically shows a sectional view in direction A-A of a color filter after the process of Step 27; and FIG. 9 schematically shows a sectional view in direction B-B of a color filter after the process of Step 27.

Preferably, before Step 26, the method further includes a step of coating a protection layer 41 on the color filter layer after which the step of manufacturing the post spacer pattern layer is performed.

As shown in FIG. 8, it shows a color filter according to the present invention, which includes a glass substrate 61, wherein a first substrate pattern layer is provided on the glass substrate 61, and an alignment mark 22 is provided in a pixel opening area of the first substrate pattern layer.

In order to reduce the area occupied by the alignment mark, the alignment mark is a graph with an area less than or equal to 2500 square microns, and the graph is any one of a rectangle, a circle, a triangle or a polygon. However, the present invention is not limited to such a size, and other shapes may also be employed, so long as the area of the alignment mark is smaller than that of the pixel opening area, the alignment mark is provided within the pixel opening area and can be identified by an exposing device for the color filter and meets the accuracy requirement of the exposing device. Preferably, the alignment mark is a square with a side length less than or equal to 50 microns. The size and area of the alignment mark are mainly provided in consideration of two aspects, i.e., the identification precision of the exposing device itself and the area of black defect that can be identified by human eyes. The minimum identification precision of an existing CF exposing device is a Mark of 50×50 μm, thus a mark with an area less than or equal to 2500 square microns (50×50 μm) is put forward in the present invention. In fact, the size and area of the alignment mark is provided in principle as small as possible within the range of the identification capability of the exposing device; thus, it will not be perceived by human eyes when displayed. According to practical tests, when the area of black defect is less than or equal to 28338 square microns (163×163 μm), it will not be perceived by human eyes when displayed.

Preferably, the first substrate pattern layer further includes a black matrix 21, and the part of the glass substrate that is not covered by the black matrix forms the pixel opening area.

Preferably, color filter layers are provided on the pixel opening area on the first substrate pattern layer, which are a red color filter layer 31, a green color filter layer 32 and a blue color filter layer 33, respectively.

Preferably, a post spacer pattern layer 51 is provided on the color filter layer.

Preferably, a protection layer 41 is further provided between the color filter layer and the post spacer pattern layer.

In the present invention, the alignment mark is provided in the pixel opening area of the first substrate pattern layer, and in the subsequent process, the alignment mark is used for aligning a mask plate with a substrate and no additional place is occupied by the alignment mark, thus the present invention can be applicable for a situation in which no white glass exists when a large-panel color filter is to be manufactured. FIG. 10 is a schematic diagram showing the alignment with a mask plate by using the color filter of the present invention.

In the present invention, an alignment mark is provided in the pixel opening area of the first substrate pattern layer, and in the subsequent process, the alignment mark is used for aligning a mask plate with a substrate and no additional place is occupied by the alignment mark, thus the present invention can be applicable for the situation in which no white glass exists when the color filter of a large-sized panel is to be manufactured. A so-called large-sized panel refers to a panel that cannot be wholly exposed at a time by a mask plate, i.e., a panel that can only be wholly exposed by mask plates via multiple spliced exposures. In the present invention, by reducing the size of the alignment mark, the alignment mark may be made in the pixel opening area of the first substrate pattern layer and appears as a tiny black defect on the panel manufactured. As the size of the alignment mark is reduced, it will not be judged as No Good according to the maintaining specification of color filters.

The present invention is applicable for the situation in which spliced exposure is required in the manufacture of large-sized panels.

The above only shows some preferred embodiments of the present invention. It should be noted that various improvements and modifications may also be made by one skilled in the art without departing from the principle of the present invention, and all these improvements and modifications are contemplated by the protection scope of the present invention.

What is claimed is:

1. A method for manufacturing a color filter, comprising:
providing a glass substrate;
forming a layer of black matrix material on the glass substrate;
exposing the black matrix material to form a first substrate pattern layer which comprises a black matrix, an alignment mark and a pixel opening area; wherein the part of the glass substrate that is not covered by the black matrix forms the pixel opening area, and the alignment mark is located in the pixel opening area.

2. The method for manufacturing a color filter according to claim 1, further comprising:
performing a first exposing and developing process according to the alignment mark, and forming a color filter layer on the first substrate pattern layer of the glass substrate.

3. The method for manufacturing a color filter according to claim 2, wherein the step of performing a first exposing and developing process according to the alignment mark and forming a color filter layer on the first substrate pattern layer of the glass substrate comprises:
coating a first layer of photoresist on the first substrate pattern layer;
aligning and placing a first mask plate, according to the alignment mark, on the glass substrate coated with the first layer of photoresist, and performing a first exposing and developing step to form a first color filter layer on the first substrate pattern layer of the glass substrate;
coating a second layer of photoresist on the first substrate pattern layer;
aligning and placing a second mask plate, according to the alignment mark, on the glass substrate coated with the second layer of photoresist, and performing a second exposing and developing step to form a second color filter layer on the first substrate pattern layer of the glass substrate;
coating a third layer of photoresist on the first substrate pattern layer;
aligning and placing a third mask plate, according to the alignment mark, on the glass substrate coated with the third layer of photoresist, and performing a third exposing and developing step to form a third color filter layer on the first substrate pattern layer of the glass substrate.

4. The method for manufacturing a color filter according to claim 3, wherein
the first color filter layer, the second color filter layer and the third color filter layer are a red color filter layer, a green color filter layer and a blue color filter layer, respectively;
the first color filter layer, the second color filter layer and the third color filter layer are a red color filter layer, a blue color filter layer and a green color filter layer, respectively;
the first color filter layer, the second color filter layer and the third color filter layer are a blue color filter layer, a red color filter layer and a green color filter layer, respectively;
the first color filter layer, the second color filter layer and the third color filter layer are a blue color filter layer, a green color filter layer and a red color filter layer, respectively;
the first color filter layer, the second color filter layer and the third color filter layer are a green color filter layer, a red color filter layer and a blue color filter layer, respectively; or
the first color filter layer, the second color filter layer and the third color filter layer are a green color filter layer, a blue color filter layer and a red color filter layer, respectively.

5. The method for manufacturing a color filter according to claim 3, further comprising:
coating a fourth layer of photoresist on the color filter layer;
aligning and placing a fourth mask plate, according to the alignment mark, on the glass substrate coated with the fourth layer of photoresist, and performing a second exposing and developing process to form a post spacer pattern layer on the color filter layer of the glass substrate.

6. A color filter comprising a glass substrate, wherein a first substrate pattern layer is provided on the glass substrate, and an alignment mark is provided in a pixel opening area of the first substrate pattern layer.

7. The color filter according to claim 6, wherein the alignment mark is a graph with an area less than or equal to 2500 square microns.

8. The color filter according to claim 7, wherein the graph is any one of a rectangle, a circle, a triangle or a polygon.

9. The color filter according to claim 7, wherein the alignment mark is a square with a side length less than or equal to 50 microns.

10. The color filter according to claim 6, wherein the first substrate pattern layer further comprises a black matrix, and the part of the glass substrate that is not covered by the black matrix forms the pixel opening area.

11. The color filter according to claim 6, wherein a color filter layer is provided on the first substrate pattern layer.

12. The color filter according to claim 11, wherein a post spacer pattern layer is provided on the color filter layer.
